(19) United States
(12) Patent Application Publication
(10) Pub. No.: US 2025/0051668 A1
(43) Pub. Date: Feb. 13, 2025

(54) METHOD AND APPARATUS FOR CO2 NEGATIVE PRODUCTION OF HEAT AND POWER IN COMBINATION WITH HYDROGEN (CHPH)

(71) Applicant: Ivar Kjell Kasin, Notodden (NO)

(72) Inventor: Ivar Kjell Kasin, Notodden (NO)

(21) Appl. No.: 18/720,624

(22) PCT Filed: Dec. 16, 2022
(86) PCT No.: PCT/NO2022/050315

§ 371 Date: Jun. 14, 2024

(30) Foreign Application Priority Data
Dec. 21, 2021 (NO) 20211569

(51) Int. Cl. C10J 3/72

(52) U.S. Cl. CPC C10J 3/721; C10J 3/723; C10J 2300/0916; C10J 2300/0969; C10J 2300/0976; C10J 2300/0986; C10J 2300/123

(57) ABSTRACT

A method and an apparatus for CO₂ negative production of heat and power in combination with hydrogen (CHPH) from carbonaceous raw material using microwaves as a heating source. The invention provides an extremely energy effective and homogenous heating of biochar enabling production of hydrogen in significant amounts. The apparatus comprises several closed vessels and is suitable for H₂ production on a small scale and locally.

### CROSS REFERENCE TO RELATED APPLICATION

The present application claims the priority benefits of International Patent Application No. PCT/NO2022/050315, filed on Dec. 16, 2022, and claims benefit of NO 20211569, filed on Dec. 21, 2021, which are hereby incorporated herein by reference in their entireties.

### FIELD OF THE INVENTION

The present invention relates to a method and an apparatus of CO₂ negative production of heat and power in combination with hydrogen (CHPH) from carbonaceous raw materials using microwaves as a heating source.

### BACKGROUND OF THE INVENTION

Microwave (MW) technology and microwave assisted pyrolysis (MAP) are well known and thoroughly discussed for instance in the background section of the present inventor's previous patent application WO 2006/083168.

WO 2006/083168 relates to an apparatus and a method for the reclamation of matter and energy from waste or other solid raw material in solid or liquid form through the use of microwave induced pyrolysis. The material to be treated is brought into a circulating conveyor system consisting of e.g. a rotating carousel-type conveyor enabling transport of the raw material in a circulating path. To obtain an inert atmosphere at start up, appropriately small quantities of water are injected into the protecting container that surrounds the carousel before the application of microwave energy for conversion to steam as an inert gas. In this way air from the closed airtight container may be displaced through suitable valve means, some of the steam combined with carbon may be reformed into hydrogen and carbon monoxide. However, the carbon of the raw material does not reach a high enough temperature to decompose H2O in significant amounts. All volatile gases are mixed and led out of the pyrolysis zone for further treatment or to fuel internal combustion engines or gas turbines for the production of electricity. The residual matter, usually in the form of charred organic matter, may be utilised as fuels or raw material for later activation or reduction purposes.

Furthermore, Multiple Hearth Furnaces (MHFs) are known for use in thermal treatment of large volumes of material.

A Multiple Hearth Furnace (MHF) is a furnace consisting of several round, stacked hearths. The hearths are basically floors within a large cylinder, and alternate between in-hearths and out-hearths. In-hearths have a large hole in the centre for material to pass through to the hearth below. Out-hearths have holes around the perimeter of the hearth for material to pass through to the hearth below. MHFs are generally constructed as utilizing a steel shell with refractory lining. Skew bands are used to support the hearths and appear as rings on the outside of the shell. The refractory lining and hearths are generally made of bricks. The hearths are self-supporting three dimensional sprung arches distributing all of their weight to the shell and skew band. A MHF is usually employed when a large volume of material needs to be thermally processed, provided that the material is moderately uniform in content and is steady, continuous fed. The material is fed into the top of the furnace and moved down from hearth to hearth until it exits at the bottom. A centre shaft equipped with rabble arms holding rabble teeth is vertically arranged through the furnace. The centre shaft spins slowly and thereby swings the rabble arms with rabble teeth ploughing the material across the hearths toward drop holes. This rabbling action stirs the material and exposes new material to the furnace atmosphere. A MHF can be operated at a wide range of temperatures. The hearths allow for zoning of atmospheres and temperatures. The energy to meet the desired temperature can come from the chemical process of the material and from burners. Burners are used to heat the MHF and dry-out the refractory lining before feed is initiated. Then burners are used to maintain temperatures as needed.

A MHF can perform several chemical processes in one and the same construction, but since there is connections between the hearts which are not completely separate, the processes overlap slightly as the producer gas flow freely between the separate zones. Production of hydrogen is not the focus in application of MHF and the hydrogen would only represent a minor part of the gas composition, and always be a result of the feedstock used and the process parameters set.

Hydrogen is extremely valuable because it can be converted into electricity at high efficiency (60% to 80%) using fuel cells and, as the simplest and most effective transportation fuel, it could displace liquid hydrocarbons. In fact, hydrogen can be derived from using hot carbon to split water molecules using less renewable energy than “green” hydrogen obtained via water electrolysis.

Therefore, there is a desire for a small scale method and apparatus to produce heat and power in combination with hydrogen (CHPH) from carbon-rich raw material.

### SUMMARY OF THE INVENTION

It is a main object of the present invention to provide a new method and apparatus for production of hydrogen from carbonaceous raw materials.

Another object of the present invention is to provide a method and apparatus for producing heat and power in combination with hydrogen (CHPH) in a CO₂ negative or at least CO₂ neutral way.

Now, the inventor has found that microwaves can be used to further heat hot carbonaceous material obtained from the microwave assisted combined heat and power process described in WO 2006/083168 as the first stage of a method for CO₂ neutral/negative hydrogen production. That is, as described in WO 2006/083168, a certain amount of hot bio-carbon is obtained forming the basis for the second step of the hydrogen production according to the present invention. By locating the hot bio-carbon into a separate second MAP reactor chamber that is completely sealed off from the first MAP reactor chamber, microwaves can be applied to reach temperatures allowing reaction with water vapour to form water gas (i.e. carbon monoxide and hydrogen) in high amounts.

### Definitions

It is to be understood that the herein disclosed invention is not limited to the particular component parts of the apparatus described or steps of the methods described since such apparatus and method may vary. It is also to be understood that the terminology used herein is for purpose of describing particular embodiments only and is not intended to be limiting.

It should be noted that, as used in the specification and the appended claim, the articles “a”, “an”, “the”, and “said” are intended to mean that there are one or more of the elements unless the context explicitly dictates otherwise. Thus, for example, reference to “a unit” or “the unit” may include several means, and the like. Furthermore, the words “comprising”, “including”, “containing” and similar wordings does not exclude other elements or steps.

The term “CHPH” as used herein means Combined Heat, Power and Hydrogen.

The term “CHP” as used herein means Combined Heat and Power.

The term “MW” as used herein means Microwave.

The term “MAP” as used herein means Microwave Assisted Pyrolysis.

The term “MHF” as used herein means Multiple Hearth Furnace.

The terms “charred organic matter”, “carbon-rich dry product(s)”, “dry product(s)”, “carbon-rich biochar”, “biochar” and “bio-carbon” as used herein have the same meaning and are used interchangeably in the present disclosure.

The terms “CO₂ negative” and “CO₂ neutral” are used interchangeably in the present disclosure.

### BRIEF DESCRIPTION OF THE DRAWINGS

FIG. 1 Illustrates an embodiment of the apparatus according to the present invention.

### DESCRIPTION OF THE PREFERRED EMBODIMENTS

In a first aspect, the present invention provides a method for production of CO₂ negative heat and power in combination with hydrogen (CHPH) from carbonaceous raw material, comprising the following steps:
providing raw material;
subjecting the raw material to torrefaction to remove water;
subjecting the obtained torrefied carbonaceous material to pyrolysis by use of microwave heating (MAP) to adequate temperature and time to produce a carbon-rich biochar and wet syngas;
further heating the carbon-rich biochar produced in the previous step to 700-1100° C. by adding microwave energy from 1-105 kW for 5-15 minutes, and adding water vapour to the heated carbon-rich biochar to produce water gas (i.e. H₂ and CO) according to the reaction C+H₂O→CO+H₂;
further heating the hot carbon-rich biochar produced in the previous step to 700-1100° C. by adding microwave energy from 1-105 kW for 5-15 minutes, and adding water vapour and CO to the hot carbon-rich biochar to produce H₂ and CO₂ according to the reaction CO+H₂O→CO₂+H₂;
further heating the hot carbon-rich biochar produced in the previous step to 700-1100° C. by adding microwave energy from 1-105 kW for 5-15 minutes, and adding CO₂ to the hot carbon-rich biochar to produce CO according to the reaction C+CO₂+2CO.

The raw material is carbonaceous raw material, preferably carbonaceous solids/carbon-rich solids such as biomass. Preferably the raw material is short distance carbonaceous raw material. Most preferably the raw material consists of primarily biomass, possibly with addition of other hydrocarbon components such as oil products, e.g. plastic and rubber. The added components may be waste-based.

Alternatively, carbonaceous pastes or liquids such as sludge and sewage may be used as raw material.

The steps of the method are separated and take place in separate vessels/reactors in the order specified above. The steps are performed directly after each other to obtain the heat within the carbon-rich dry products/biochar without cooling between the steps.

In a preferred embodiment of the method, the torrefied carbonaceous material is heated to 300-600° C., more preferable to 500-600° C., for a period of 5-15 minutes to produce a carbon-rich biochar and wet syngas.

The carbon-rich dry products obtained in the pyrolysis have a large surface due to the microwaves used for heating.

The frequencies of the microwaves used in the process vary continuously and are based on the dielectric properties of the raw material.

The wet syngas produced during the MAP is led out of the pyrolysis zone, and utilized and converted in production of heat and power in combination (CHP). The power may be used for production of microwaves to be used in the process.

In another preferred embodiment of the method, the carbon-rich biochar obtained in any step for further heating is heated to temperatures in the area of about 1000° C. by adding microwave energy.

In another embodiment of the method, one or more catalysts may be introduced together with hot carbon-rich biochar and H₂O in the step producing water gas. The water gas produced may comprise 40% or more of H₂ and 30% or more of CO.

H₂ and CO are led out of the reaction zone, and may be separated and stored individually.

In still another embodiment of the method, one or more catalysts may be introduced together with hot carbon-rich biochar, H₂O and CO in the step producing H₂ and CO₂ (i.e. the water-gas shift reaction/WGSR). The CO added may be the CO produced in the previous steps.

Catalysts to be added in the two steps mentioned above may be Cu/Zn/Al and Fe/Cr/Cu based catalysts.

Additional amounts of H₂ is produced in the WGSR step. H₂ and CO₂ produced in this step are led out of the reaction zone and separated. H2 may be stored together with H2 produced in the previous step. CO₂ may be stored separately and/or added to the hot carbon-rich biochar produced in the WGSR step in the last step of the present method. CO₂ from another source may be added in this step as well. Consequently, a CO₂ neutral or CO₂ negative process producing H₂ in combination with heat and power (CHPH) is achieved.

The CO produced in the last step of the method is led out of the reaction zone and may be stored together with CO previously produced. The CO may be used in a further optional step (not mentioned above) together with hot carbon-rich biochar produced in the last step and additional water vapour in production of H₂ (i.e. a further WGSR step).

The present invention provides a new method for combined production of heat, power and hydrogen (CHPH). By taking care of and utilizing hot carbon-rich material obtained by MAP in a further step where MW heating at 700-1100° C. is performed and water vapour is added, production of hydrogen in significant amounts is achieved. The following WGSR step increases the hydrogen yield. By carrying out the last step of the present method, a CO₂ neutral and even a CO₂ negative CHPH process may be achieved.

In an embodiment of the invention, the method comprises only the step up to production of hydrogen by the reaction C+H₂O→CO+H₂. That is, the two last steps of the method disclosed above are not included.

In another embodiment of the invention, the method comprises only the step up to of hydrogen by the reaction CO+H₂O→CO₂+H₂. That is, the last step of the method disclosed above is not included.

In a second aspect, the present invention provides an apparatus for carrying out the method described above. That is, the present invention provides an apparatus 1 for production of heat and power in combination with hydrogen from carbonaceous raw material using MW heating, comprising several closed vessels, such as reactors.

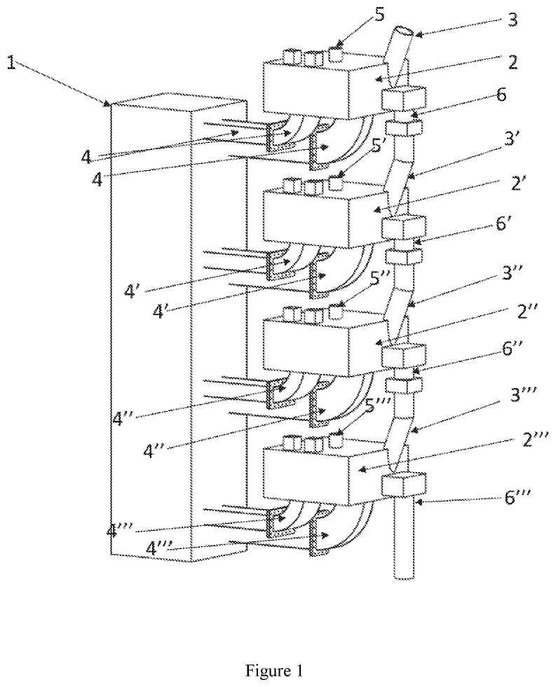

In one embodiment, as shown in FIG. 1, the apparatus 1 comprises:
a reactor 2 for MW induced pyrolysis with an inlet 3 for supply of torrefied carbonaceous material, a pathway inside the reactor connected to means for moving the pathway on which the torrefied carbonaceous material is placed, one or more MW generating equipment(s) 4, an outlet of gas 5, and an outlet 6 of hot carbon-rich material connected to
a reactor 2′ via an inlet 3′, with a further inlet for supply of water vapour, a pathway inside the reactor connected to means for moving the pathway on which the carbon-rich material is placed, one or more MW generating equipment(s) 4′, an outlet of gas 5′, and an outlet 6′ of hot carbon-rich material connected to
a reactor 2″ via an inlet 3″, with a further inlet for supply of water vapour and CO (e.g. obtained in reactor 2′), a pathway inside the reactor connected to means for moving the pathway, one or more MW generating equipment(s) 4″, an outlet of gas 5″, and an outlet 6″ of hot carbon-rich material connected to
a further reactor (not shown) via an inlet, with a further inlet for supply of CO₂ (e.g. obtained in reactor 2″, or from another source), a pathway inside the reactor connected to means for moving the pathway on which the carbon-rich material is placed, one or more MW generating equipment(s), an outlet of gas, and an outlet of carbon-rich material, optionally connected to
a further reactor (2″″, not shown) for further processing.

The torrefied carbonaceous material supplied in reactor 2 may be prepared in a vessel/reactor in front thereof, wherein carbonaceous raw material is supplied through an inlet, preheated and/or torrefied in the vessel/reactor, and water vapour is removed through an outlet. The torrefaction reactor may be connected to reactor 2 via the inlet 3.

The vessels/reactors of the apparatus may be square or circular, but it is not necessary or limited to that. Screw reactors and gravity reactors are other examples of useful vessels/reactors. Any shapes and forms of the vessels may do provided they include a movable pathway or means for moving material placed on or in the pathway/means through the vessels/reactors. Suitable means to transport material may be a carousel, or a succession of conveyor belts.

The interior pathway portion of the reactors is of a non-conductive material such as fused quartz. Fused quartz has low dielectric constant and dielectric loss, ensuring that it will not heat when exposed to microwave energy.

In case of circular reactors, the interior pathway portion may consist of several concentric cylindrical pieces.

The means for moving the pathway may be a gear shaft which protrudes through the centre of the reactor 2/2′/2″.

The MW generating equipment(s) 4/4′/4″ may be WR975 waveguide ports or WR430 waveguide ports. The MW generating equipment(s) 4/4′/4″ may be placed from the bottom, the side and/or the top surface(s) of the reactor 2/2′/2″ wherein a window portion penetrable by microwaves is present. For example, The MW generating equipment(s) 4/4′/4″ may be placed from the bottom surface of the reactor with a horseshoe-shaped extrusion providing the range of potential locations for each waveguide port. Typically, two or more waveguides are used.

The outlet 6/6′/6″ may be a screw-conveyor or any other device for bringing the dry end-products (i.e. hot carbon-rich material) out at the end of the pathway or at the side wall of the reactor 2/2′/2″.

In one embodiment of the apparatus, a circular outgassing port may be placed on the top of the reactors 2/2′/2″ to prevent pressure build-up during operation of the reactors.

In reactor 2 of the apparatus, wet gas is produced and led out through outlet 5 for storage and further use in production of thermal heat and power/electricity.

In reactor 2′ of the apparatus, water gas (i.e. H₂ and CO) is produced and led out through outlet 5′. The water gas may be introduced to separation means (not shown) to separate H₂ and CO further transferred to means for individual storage.

CO from the above mentioned storage means may be added to reactor 2″.

In reactor 2″ of the apparatus, the gases produced and led out through outlet 5″ are H₂ and CO₂. The said gases may be introduced to separation means to separate H₂ and CO₂ further transferred to means for individual storage.

CO₂ from the above mentioned storage means may be added to the further reactor to react with the carbon-rich material to produce CO.

The carbon-rich material is always the hottest item in the apparatus due to the MWs, not the reactors and their constituents or other equipment. Thus, an extremely energy effective and homogenous heating is obtained.

The apparatus of the invention is suitable for H₂ production on a small scale and locally. In particular, the apparatus enables production of CO₂ negative heat and power in combination with hydrogen (CHPH) from carbonaceous raw material.

The apparatus is based on mobile facilities, i.e. container-based/module-based. Multiple modules can increase the capacity and run multiple reactions.

In a preferred embodiment of the apparatus according to the invention, the vessels/reactors are separate units.

In another embodiment of the apparatus, only one reactor is needed. However, in such a case the reactor will be divided with locks creating chambers wherein the different production steps are carried out. That is, the vessels/reactors are included in one device divided with locks creating chambers constituting several means/reactors.

The H₂ produced in the method and apparatus of the invention may e.g. be used as fuel for cars, ferries, planes etc.

The invention is explained in more detail in the example below. The example is only meant to be illustrative and shall not be considered as limiting.

### EXAMPLE

The body of the reactors 2/2′/2″ are cylindrical heating regions with a domed roof. The reactor exterior is fabricated from stainless steel. Carbonaceous material/biomass is fed through an inlet 3/3′/3″ on the roof, which is deposited onto a pathway inside the reactor 2/2′/2″. The interior pathway portion of the reactor contains several concentric cylindrical pieces of fused quartz used to contain the biomass as it travels along a circular path through the reactor. The biomass material then leaves the reactor 2/2′/2″ through an outlet 8/8′/8″ which is a screw-conveyor at the end of the pathway that penetrates the side wall of the reactor 2/2′/2″.

The central region of the reactor interior does not contain any material due to the means for moving the pathway, i.e. a gear shaft which protrudes through the centre of the reactor/2′/2″. A stainless-steel cover resting on the fused silica wall is used to close off this section of the reactor and prevent biomass material from entering. Microwave power is fed into the reactor via two waveguides 4/4′/4″, i.e. WR975 waveguide ports from the bottom surface, with a horseshoe-shaped extrusion providing the range of potential locations for each waveguide port. A circular outgassing port on the roof is used to prevent pressure build-up during operation of the reactor 2/2′/2″.

The person skilled in the art realizes that the present invention is not limited to the preferred embodiments described above. Changes and modifications in the specifically-described embodiments may be carried out without departing from the principles of the present invention, which is intended to be limited only by the scope of the appended claims as interpreted according to the principles of patent law including the doctrine of equivalents.

1. A method for production of CO₂ negative heat and power in combination with hydrogen (CHPH) from carbonaceous raw material, the method comprising the steps of:
providing raw material;
subjecting the raw material to torrefaction to remove water and obtain a torrefied carbonaceous material;
subjecting the torrefied carbonaceous material to pyrolysis by use of microwave heating (MAP) to adequate temperature and time to produce a carbon-rich biochar and wet syngas;
heating the carbon-rich biochar to 700-1100° C. by adding microwave energy from 1-105 kW for 5-15 minutes to obtain a heated carbon-rich biochar, and adding water vapour to the heated carbon-rich biochar to produce water gas (H₂ and CO) according to the reaction C+H₂O→CO+H₂;
heating the heated carbon-rich biochar to 700-1100° C. by adding microwave energy from 1-105 kW for 5-15 minutes to obtain a resulting heated carbon-rich biochar, and adding water vapour and CO to the resulting heated carbon-rich biochar to produce H₂ and CO₂ according to the reaction CO+H₂O→CO₂+H₂; and
heating the resulting heated carbon-rich biochar to 700-1100° C. by adding microwave energy from 1-105 kW for 5-15 minutes to obtain a hot carbon-rich biochar, and adding CO₂ to the hot carbon-rich biochar to produce CO according to the reaction C+CO₂→2CO.

2. The method according to claim 1, wherein the carbonaceous raw material is solids or carbon-rich solids such as biomass or a mixture of biomass and other hydrocarbon components.

3. The method according to claim 1, wherein each heating step is separated and performed directly one after another without intermediate cooling.

4. The method according to claim 1, wherein one or more catalysts are added together with the water vapour.

5. The method according to claim 1, wherein the CO added to the resulting heated carbon-rich biochar is produced in a previous step.

6. The method according to claim 1, wherein the CO₂ added to the hot carbon-rich biochar is produced in a previous step or supplied from another CO₂ source.

7. (canceled)

8. An apparatus for production of heat and power in combination with hydrogen from carbonaceous raw material using microwave (MW) heating and including one or more closed vessels or reactors, the apparatus comprising:
a first reactor for MW induced pyrolysis having a first inlet for supply of torrefied carbonaceous material, a first pathway inside the first reactor connected to a first means for moving the first pathway on which the material torrefied carbonaceous is placed, one or more first MW generating units, a first outlet of gas, and a first outlet of hot carbon-rich material;
a second reactor connected to the first reactor via a second inlet, the second reactor having a first vapor inlet for supply of water vapour, a second pathway inside the second reactor connected to a second means for moving the second pathway on which the carbon-rich material is placed, one or more second MW generating units, a second outlet of gas, and a second outlet of hot carbon-rich material;
a third reactor connected to the second reactor via a third inlet, the third reactor having a second vapor inlet for supply of water vapour and CO, a third pathway inside the third reactor connected to a third means for moving the third pathway, one or more third MW generating units, a third outlet of gas, and a third outlet of hot carbon-rich material; and
a fourth reactor connected to the third reactor via a fourth inlet, the fourth reactor having a third vapor inlet for supply of CO₂, a fourth pathway inside the fourth reactor connected to a fourth means for moving the fourth pathway on which the carbon-rich material is placed, one or more fourth MW generating units, a fourth outlet of gas, and a fourth outlet of carbon-rich material.

9. The apparatus according to claim 8, wherein an interior of the first, second, third, and fourth reactors is formed from a non-conductive material, and wherein the interior is formed from fused quartz.

10. The apparatus according to claim 9, wherein the first, second third, and fourth reactors are separate units.

11. The apparatus according to claim 10, wherein one or more of the first, second, third, and fourth reactors are circular.

12. The apparatus according to claim 8, wherein the first, second, third, and fourth reactors are included in one device divided with locks creating chambers constituting several vessels.

13. (canceled)
